(19) United States
(12) Patent Application Publication
(10) Pub. No.: US 2023/0400586 A1
(43) Pub. Date: Dec. 14, 2023

(54) Method for Operating a First Illumination Device, a Second Illumination Device and an Optical Sensor, Control Device for Carrying Out Such a Method, Gated Camera Apparatus Comprising Such a Control Device, and Motor Vehicle Comprising Such a Gated Camera Apparatus

(71) Applicant: Daimler Truck AG, Leinfelden-Echterdingen (DE)

(72) Inventor: Fridtjof STEIN, Ostfildern (DE)

(21) Appl. No.: 18/253,563

(22) PCT Filed: Oct. 7, 2021
(86) PCT No.: PCT/EP2021/077664

§ 371 Date: May 18, 2023

(30) Foreign Application Priority Data
Nov. 19, 2020 (DE) 10 2020 007 061.2

(51) Int. Cl. G01S 17/894; G01S 17/18; G01S 7/481; G01S 17/931

(52) U.S. Cl. CPC G01S 17/894; G01S 17/18; G01S 7/4815; G01S 17/931

(57) ABSTRACT

A method for operating a first illumination device, a second illumination device, and an optical sensor includes controlling the first illumination device, the second illumination device, and the optical sensor in a temporally coordinated manner and assigning a visible distance range to the coordinated control. During an illumination by the first illumination device, the optical sensor captures a first image by the coordinated control. During an illumination by the second illumination device, the optical sensor captures a second image by the coordinated control. During a time of an absence of an illumination by the first illumination device and the second illumination device, the optical sensor captures a third image. A difference captured image is formed from the first captured image, the second captured image, and the third captured image.

### BACKGROUND AND SUMMARY OF THE INVENTION

The invention relates to a method for operating a first illumination device, a second illumination device and an optical sensor, to a control device for carrying out such a method, to a gated camera apparatus comprising such a control device and to a motor vehicle comprising such a gated camera apparatus.

Methods for operating an illumination device and an optical sensor are known. By way of example, both U.S. Pat. No. 5,034,810 A and US 20180203122 A1 already disclose methods for operating an illumination device and a gated camera apparatus. The known methods are disadvantageous in that, on the one hand, only a single illumination device is taken into account and, on the other hand, an environment with low ambient lighting is a prerequisite.

In addition, DE 102017204836 A1 discloses a method in which two illumination devices are mounted spatially separated on a motor vehicle. Furthermore, DE 102020003199 A1 also discloses a method in which the illumination device and the optical sensor, or the gated camera apparatus, are controlled in a temporally coordinated manner to produce at least two successive captured images by means of the optical sensor. However, all of these known methods are unsuitable in situations with daylight and/or strong sunlight.

Furthermore, the publication “Gated2Depth: Real-Time Dense Lidar From Gated Images” by Tobias Gruber et al. (https://arxiv.org/pdf/1902.04997.pdf) presents a method for creating a captured image using distance information in real time. The problem here is that this method can only be used at a range of up to 80 m.

The invention is therefore based on the object of providing a method for operating a first illumination device, a second illumination device and an optical sensor, a control device for carrying out such a method, a gated camera apparatus comprising such a control device, and a motor vehicle comprising such a gated camera apparatus, wherein the stated disadvantages are at least partially overcome, and preferably avoided.

The object is achieved in particular by providing a method for operating a first illumination device, a second illumination device and an optical sensor, wherein the first illumination device, the second illumination device and the optical sensor are controlled in a temporally coordinated manner and a visible distance range is assigned to the coordinated control. During an illumination by means of the first illumination device, the optical sensor captures a first image by means of the coordinated control. During an illumination by means of the second illumination device, the optical sensor captures a second image by means of the coordinated control. In the absence of illumination by means of one of the illumination devices, the optical sensor captures a third image. Furthermore, a difference captured image is formed from the first captured image, the second captured image and the third captured image.

The third captured image corresponds in particular to an environment image, in particular a daylight image. Advantageously, the influence of the ambient light, in particular of the daylight, can be calculated by subtracting the third captured image from the first captured image and the second captured image. This makes a more robust and more reliable evaluation of the difference captured image possible.

The method for generating captured images by means of controlling at least one illumination device and an optical sensor in a temporally coordinated manner is in particular a method known as gated imaging; in particular, the optical sensor is a camera which is sensitively actuated only in a specific, restricted time period. This is referred to as gated control and the camera is therefore a gated camera. The at least one illumination device is also correspondingly temporally controlled only in a specific, selected time interval in order to light up a scene on the object side.

In particular, the first illumination device and the second illumination device emit a predefined number of light pulses, preferably each with a duration of between 5 ns and 20 ns. The beginning and the end of the exposure of the optical sensor is coupled to the number and duration of the emitted light pulses. As a result, a specific visible distance range can be detected by the optical sensor through the temporal control, on the one hand, of the first illumination device and the second illumination device and, on the other hand, of the optical sensor with a correspondingly defined spatial position, i.e., in particular specific distances of a near and a far boundary of the visible distance range from the optical sensor.

The visible distance range is that—object-side—range in three-dimensional space which is imaged in a two-dimensional captured image onto an image plane of the optical sensor by the number and duration of light pulses of the first illumination device and/or of the second illumination device in conjunction with the start and end of the exposure of the optical sensor.

Whenever the term “object side” is used here and in the following, it refers to an area in real space. Whenever the term “image side” is used here and in the following, it refers to an area on the image plane of the optical sensor. The visible distance range is given in this case on the object side. This corresponds to an image-side area on the image plane assigned by the laws of imaging and the temporal control of the first illumination device, the second illumination device and the optical sensor.

Depending on the start and end of the exposure of the optical sensor following the beginning of the illumination by the first illumination device and/or the second illumination device, light pulse photons impinge on the optical sensor. The further the visible distance range is away from the first illumination device and/or the second illumination device and the optical sensor, the longer the time duration until a photon which is reflected in this distance range impinges on the optical sensor. Therefore, the time interval between an end of the illumination and a beginning of the exposure increases, the further away the visible distance range is from the first illumination device, the second illumination device and the optical sensor.

It is thus particularly possible, according to one embodiment of the method, to define the position and the spatial width of the visible distance range, in particular a spacing between the near boundary and far boundary of the visible distance range, by correspondingly suitable selection of the temporal control of the first illumination device and/or the second illumination device on the one hand, and of the optical sensor on the other hand.

In a preferred embodiment of the method, the visible distance range is predefined, with the temporal coordination of the first illumination device and/or of the second illumination device, on the one hand, and of the optical sensor, on the other hand, being determined and accordingly predefined therefrom.

In a preferred embodiment, the illumination device has at least one surface emitter, in particular what is known as a VCSE laser. As an alternative or in addition, the optical sensor is preferably a camera.

In one embodiment of the method, the third image is captured after the first captured image and after the second captured image.

In a further embodiment of the method, the third image is captured after the first captured image. The second image is captured after the third captured image.

In a further embodiment of the method, the third image is captured before the first captured image and the second captured image.

Advantageously, the method can be carried out continuously. In one embodiment of the method, when the method is carried out continuously, the first captured image, the second captured image and the third captured image are captured the same number of times per unit of time.

In a further embodiment of the method, when the method is carried out continuously, one image, alternately selected from the first image and the second image, is captured in alternation with the third image, that is, for example, a sequence of the type: a first image, then a third image, then a second image, then a third image, then a first image again, and so on. This increases the time interval between the individual illuminations by means of the first illumination device and between the individual illuminations by means of the second illumination device. This longer time interval enables optimum cooling of the first illumination device or the second illumination device and thus illumination with a higher energy output.

In a further preferred embodiment of the method, the first image, the second image and the third image are captured in a time interval of less than 0.01 seconds, preferably less than 0.001 seconds.

According to a refinement of the invention, it is provided that a first partial difference captured image is formed as the difference between the first captured image and the third captured image. Furthermore, a second partial difference captured image is formed as the difference between the second captured image and the third captured image. The difference captured image is then formed as the difference between the first partial difference captured image and the second partial difference captured image.

According to a refinement of the invention, it is provided that a method for image registration is applied to the first captured image, the second captured image and the third captured image before the difference captured image is formed. Advantageously, the image registration compensates for the inherent motion of the motor vehicle.

In one embodiment of the method, a method for image registration is applied to the first captured image and the third captured image, whereby the third captured image is matched to the first captured image to form the first partial difference recorded image. In addition, a method for image registration is applied to the second captured image and the third captured image, whereby the third captured image is matched to the second captured image to form the second partial difference captured image. After forming the first partial difference captured image and the second partial difference captured image, a method for image registration is applied to the first partial difference captured image and the second partial difference captured image.

In a preferred embodiment of the method, a method for image registration is applied to the first captured image and the third captured image, whereby the first captured image is matched to the third captured image. In addition, a method for image registration is applied to the second captured image and the third captured image, whereby the second captured image is matched to the third captured image. This advantageously obviates the need for further image registration because the first captured image and the second captured image are matched to the third captured image. The first partial difference captured image and the second partial difference captured image are thus registered automatically.

According to a refinement of the invention, it is provided that objects are searched for in the difference captured image. Advantageously, only image information that can be seen either only in the first captured image or only in the second captured image can be seen in the difference captured image. This image information includes shadows that are produced by an object due to the different illumination by means of the first illumination device and the second illumination device. An object can be inferred on the basis of this image information, in particular these shadows.

In one preferred embodiment of the method, objects are only detected from a predetermined horizontal image-side shadow width Δu onwards. This predetermined horizontal image-side shadow width Δu enables a robust and reliable object detection in the difference captured image.

According to a refinement of the invention, it is provided that a distance measurement is carried out in the difference captured image.

In a preferred embodiment of the method, the distance measurement is performed by means of a method which is known from the German laid-open patent specification DE 10 2020 002 994 A1. To carry out the method, the object-side position of the visible distance range, the image-side position of the visible distance range and the base point image line of the object must be known. The object-side position of the visible distance range is known from the coordinated control of the first illumination device, the second illumination device and the optical sensor. The image-side position of the visible distance range is known both from the first captured image and from the second captured image. The base point image line of the object is known from the difference captured image. The distance of the object is thereby estimated, in particular on the basis of the shadow of the object.

The base point image line of a shadow can vary depending on the shape of the shadow. In particular, the accuracy of determining the base point image line depends on the shape of the shadow. Especially in the case of triangular shadows, which become wider from the bottom to the top of the image, object detection takes place from the predetermined horizontal image-side shadow width Δu onwards. Such triangular shadows are produced in particular in the case of a horizontal distance of, on the one hand, the illumination devices from each other and, on the other hand, at least one illumination device and the optical sensor. The distance measurement as a function of the predetermined horizontal image-side shadow width Δu is nevertheless reliable. The reliability is illustrated on the basis of the following considerations.

Provided that the object is flat in the direction of travel, in particular in the x direction, of the motor vehicle, an object-side shadow distance x_{W} of an arbitrary position within the shadow, in particular a triangular shadow, to the optical sensor, the object-side horizontal shadow width y_{W} of the shadow at the arbitrary position, the image plane distance f of an image plane of the optical sensor from the lens of the optical sensor, and the predetermined horizontal image-side shadow width can be set in the proportional relationship

$$\frac{Δ u}{f} = \frac{{y}_{w}}{{x}_{W}} \qquad ( 1 )$$

using the intercept theorem. Likewise, a horizontal illumination distance y_{B} of one of the two illumination devices to the optical sensor, the object-side shadow distance x_{W} and an object distance x_{O} of the object to the optical sensor can be set in the proportional relationship

$$\frac{{x}_{W}}{{y}_{B}} = \frac{{x}_{W} - {x}_{O}}{{x}_{O}} \qquad ( 2 )$$

using the intercept theorem. Combining the formulae (1) and (2) gives a distance difference Δx with

$$Δ x = {x}_{W} - {x}_{O} = \frac{{x}_{O}^{2}}{\frac{f \times {y}_{B}}{Δ u} - {x}_{O}} \qquad ( 3 )$$

between the arbitrary position x_{W}, at which the object-side shadow distance is viewed, and the object distance x_{O}. For an illumination distance y_{B}=2 m, an image plane distance f=5000 px and a predetermined horizontal image-side shadow width Δu=3 px, given an actual object distance x_{O}=200 m, a distance difference Δx of approx. 13 m results. This means that the error of the distance measurement is only 7.5%. This error is acceptable for an object distance x_{O} of 200 m.

The object is also achieved by providing a control device which is configured to carry out a method according to the invention or a method according to one or more of the above-described embodiments. The control device is preferably in the form of a computing device, particularly preferably a computer, or a controller, in particular a motor vehicle controller. The advantages that have already been explained in conjunction with the method result in particular in conjunction with the control device.

The object is also achieved by providing a gated camera apparatus which has a first illumination device, a second illumination device, an optical sensor and a control device according to the invention or a control device according to one or more of the above-described exemplary embodiments. The control device is preferably operatively connected to the first illumination device, the second illumination device and the optical sensor and is configured to control them. The advantages that have already been explained in conjunction with the method and the control device result in particular in conjunction with the gated camera apparatus.

According to a refinement of the invention, it is provided that the first illumination device and the second illumination device are arranged horizontally offset from each other. In particular, the first illumination device and/or the second illumination device are arranged horizontally offset from the optical sensor.

According to a refinement of the invention, it is provided that the first illumination device and the second illumination device are arranged vertically offset from each other. In particular, the first illumination device and/or the second illumination device are arranged vertically offset from the optical sensor.

In a preferred exemplary embodiment, the first illumination device and the second illumination device are arranged both vertically and horizontally offset from each other. Alternatively, or additionally, a first distance between the first illumination device and the optical sensor is smaller than a second distance between the second illumination device and the optical sensor. Particularly preferably, the first distance is less than 50 cm, preferably less than cm, preferably less than 10 cm. Particularly preferably, in addition, the second distance is more than 50 cm, preferably more than 100 cm, preferably more than 150 cm.

The object is lastly also achieved by providing a motor vehicle comprising a gated camera apparatus or a gated camera apparatus according to one or more of the above-described exemplary embodiments. The advantages that have already been explained in conjunction with the method, the control device and the gated camera apparatus result in particular in conjunction with the motor vehicle.

In one advantageous embodiment, the motor vehicle is a heavy-goods vehicle. The optical sensor and the first illumination device are arranged above the windscreen and are at a distance to each other—the first distance—of less than 50 cm, preferably less than 20 cm, preferably less than 10 cm. The second illumination device is preferably arranged in the area of the bumper.

The invention is explained in more detail with reference to the drawings.

### BRIEF DESCRIPTION OF THE DRAWINGS

FIG. 1 shows a schematic illustration of an exemplary embodiment of a motor vehicle with an exemplary embodiment of a gated camera apparatus;

FIGS. 2a-2f show a schematic illustration of an exemplary embodiment of a method for operating the first illumination device, the second illumination device and the optical sensor; and

FIG. 3 shows a schematic illustration for determining a distance difference Δx.

### DETAILED DESCRIPTION OF THE DRAWINGS

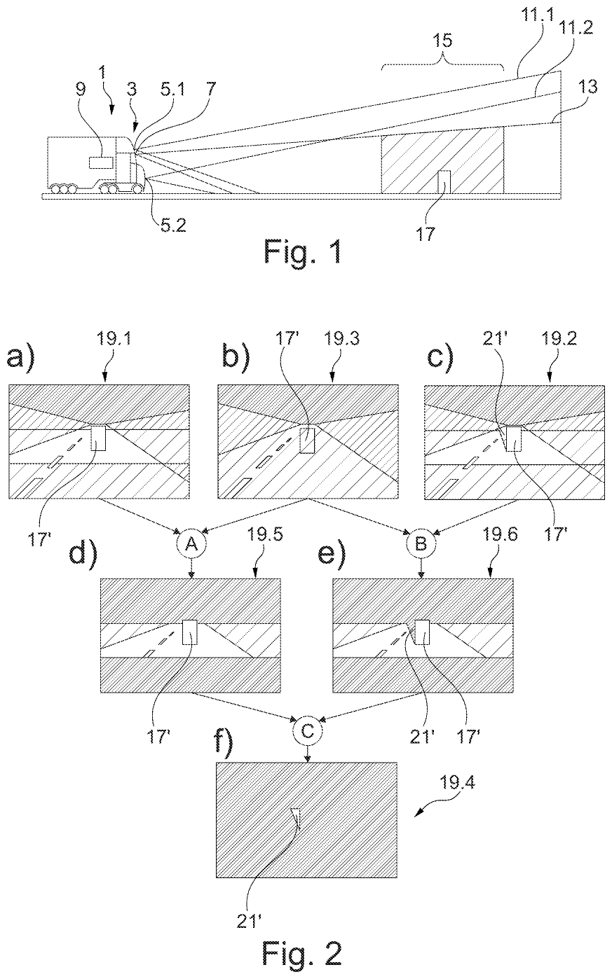

FIG. 1 shows a schematic illustration of an exemplary embodiment of a motor vehicle 1 with an exemplary embodiment of a gated camera apparatus 3. The gated camera apparatus 3 has a first illumination device 5.1, a second illumination device 5.2, an optical sensor 7, in particular a camera, and a control device 9. The control device 9 is operatively connected (in a manner not shown explicitly) to the first illumination device 5.1, the second illumination device 5.2 and the optical sensor 7 and is configured to control them.

The first illumination device 5.1 and the second illumination device 5.2 are preferably arranged vertically offset from each other. Alternatively, or additionally, the first illumination device 5.1 and the second illumination device 5.2 are preferably arranged horizontally offset from each other.

A first distance between the first illumination device 5.1 and the optical sensor 7 is preferably less than a second distance between the second illumination device 5.2 and the optical sensor 7. Particularly preferably, the first distance is less than 50 cm, preferably less than 20 cm, preferably less than 10 cm. Particularly preferably, in addition, the second distance is more than 50 cm, preferably more than 100 cm, preferably more than 150 cm.

The first illumination device 5.1 and the second illumination device 5.2 preferably have at least one surface emitter, in particular what is known as a VCSE laser.

FIG. 1 depicts in particular a first illumination frustum 11.1 of the first illumination device 5.1, a second illumination frustum 11.2 of the second illumination device 5.2 and an observation region 13 of the optical sensor 7. A visible distance range 15 which results as a subset of the first illumination frustum 11.1 of the first illumination device 5.1, of the second illumination frustum 11.2 of the second illumination device 5.2 and of the observation region 13 of the optical sensor 7 is also shown in hatched lines. An object 17 is arranged within the visible distance range 15.

The control device 9 is configured in particular to carry out an embodiment, described in more detail in FIG. 2, of a method for operating the first illumination device 5.1, the second illumination device 5.2 and the optical sensor 7.

The first illumination device 5.1, the second illumination device 5.2 and the optical sensor 7 are controlled in a temporally coordinated manner, and the visible distance range 15 is assigned to the coordinated control. During an illumination by means of the first illumination device 5.1, the optical sensor 7 captures a first image 19.1 by means of the coordinated control. The first captured image 19.1 is shown in FIG. 2 a). During an illumination by means of the second illumination device 5.2, the optical sensor 7 also captures a second image 19.2 by means of the coordinated control. The second captured image 19.2 is shown in FIG. 2 c). In addition, in the absence of illumination by means of the first illumination device 5.1 or the second illumination device 5.2, the optical sensor 7 captures a third image 19.3. The third captured image 19.3 is shown in FIG. 2 b). Subsequently, a difference captured image 19.4 is formed from the first captured image 19.1, the second captured image 19.2 and the third captured image 19.3. The difference captured image 19.4 is shown in FIG. 2 f).

An image-side object 17′ is visible in the first captured image 19.1, the second captured image 19.2 and the third captured image 19.3. In an optimal case, no shadow is visible in the first captured image 19.1, as shown in FIG. 2 a). In addition, the second captured image 19.2 shows a shadow 21′ of the object 17 that is visible on the image side. The shadow 21′ visible on the image side arises because the second illumination device 5.2 and the optical sensor 7 are arranged at a distance from each other, in particular horizontally offset from each other. Preferably, the first illumination device 5.1 and the second illumination device 5.2 are arranged in such a way that the shadows 21′ visible on the image side in the first captured image 19.1 and the second captured image 19.2 are different from each other.

Because the shadows 21′ visible on the image side in the first captured image 19.1 and the second captured image 19.2 are different from each other, only the shadow 21′ visible on the image side can still be seen in the difference captured image 19.4 in FIG. 2 f).

Preferably, the third image 19.3 is captured at a time between the first image 19.1 and the second image 19.2 being captured. Alternatively, the third image 19.3 is captured at a time before the first image 19.1 and the second image 19.2 are captured. Alternatively, the third image 19.3 is captured at a time after the first image 19.1 and the second image 19.2 have been captured.

Preferably, the first image and the second image are captured in a time interval of less than 0.1 seconds, preferably in a time interval of less than 0.01 seconds.

Preferably, in a method step A, a first partial difference captured image 19.5 is formed as the difference between the first captured image 19.1 and the third captured image 19.3. The first partial difference captured image 19.5 is shown in FIG. 2 d). In a method step B, a second partial difference captured image 19.6 is formed as the difference between the second captured image 19.2 and the third captured image 19.3. The second partial difference captured image 19.6 is shown in FIG. 2 e). By subtracting the third captured image 19.3 from the first captured image 19.1 and the second captured image 19.2, the background information is removed from the captured image 19.1 and the second captured image 19.2 and the unexposed areas, in particular the image-side shadow 21′, are more clearly visible in the first partial difference captured image 19.5 and the second partial difference captured image 19.6. In a method step C, the difference captured image 19.4 is formed as the difference between the first partial difference captured image 19.5 and the second partial difference captured image 19.6.

Preferably, in method steps A and B, an additional method for image registration is carried out. Preferably, the first captured image 19.1 and the second captured image 19.2 are thereby matched to the third captured image 19.3. An additional method for image registration can also be carried out in method step C. However, image registration is not necessary in method step C if the first captured image 19.1 and the second captured image 19.2 were matched to the third captured image 19.3 is method steps A and B.

A method for object detection is preferably carried out in the difference captured image 19.4.

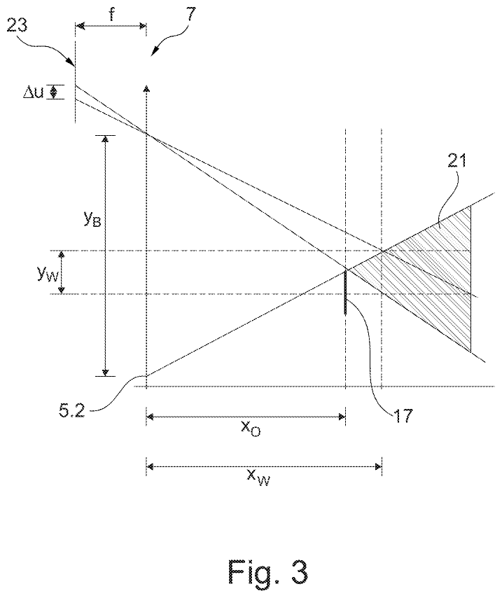

FIG. 3 shows a plan view of the situation, in particular an x-y plane, from FIG. 1. The second illumination device 5.2 and the optical sensor 7 are arranged horizontally offset from each other. The object-side shadow region 21 corresponds to the shadow 21′ of the object 17 which is visible on the image side and arises during an illumination by means of the second illumination device 5.2. Using the intercept theorem, an object-side shadow distance x_{W} of an arbitrary position within the object-side shadow 21 to the optical sensor 7, the object-side horizontal shadow width y_{W} of the shadow at the arbitrary position, the image plane distance f of an image plane 23 of the optical sensor 7 from the lens of the optical sensor 7, and the predetermined horizontal image-side shadow width Δu can be set in the proportional relationship (1) Likewise, using the intercept theorem, a horizontal illumination distance y_{B} of one of the second illumination devices 5.2 to the optical sensor 7, the object-side shadow distance x_{W} and an object distance x_{O} of the object 17 to the optical sensor 7 can be set in the proportional relationship (2). Combined, a difference distance Δx between the arbitrary position x_{W}, at which the object-side shadow distance is viewed, and the object distance x_{O} is then calculated with formula (3).

1.-10. (canceled)

11. A method for operating a first illumination device (5.1), a second illumination device (5.2), and an optical sensor (7), comprising the steps of:
controlling the first illumination device (5.1), the second illumination device (5.2), and the optical sensor (7) in a temporally coordinated manner;
assigning a visible distance range (15) to the coordinated control;
during an illumination by the first illumination device (5.1), the optical sensor (7) captures a first image (19.1) by the coordinated control;
during an illumination by the second illumination device (5.2), the optical sensor (7) captures a second image (19.2) by the coordinated control;
during a time of an absence of an illumination by the first illumination device (5.1) and the second illumination device (5.2), the optical sensor (7) captures a third image (19.3); and
forming a difference captured image (19.4) from the first captured image (19.1), the second captured image (19.2), and the third captured image (19.3).

12. The method according to claim 11, further comprising the steps of:
forming a first partial difference captured image (19.5) as a difference between the first captured image (19.1) and the third captured image (19.3); and
forming a second partial difference captured image (19.6) as a difference between the second captured image (19.2) and the third captured image (19.3);
wherein the difference captured image (19.4) is formed as a difference between the first partial difference captured image (19.5) and the second partial difference captured image (19.6).

13. The method according to claim 11, further comprising the step of applying a method for image registration to the first captured image (19.1), the second captured image (19.2), and the third captured image (19.3) before forming the difference captured image (19.4).

14. The method according to claim 11, further comprising the step of searching for objects (17) in the difference captured image (19.4).

15. The method according to claim 11, further comprising the step of carrying out a distance measurement in the difference captured image (19.4).

16. A control device (9) configured to perform the method according to claim 11.

17. A gated camera apparatus (3), comprising:
a first illumination device (5.1);
a second illumination device (5.2);
an optical sensor (7); and
a control device (9) configured to perform the method according to claim 11.

18. The gated camera apparatus (3) according to claim 17, wherein the first illumination device (5.1) and the second illumination device (5.2) are disposed horizontally offset from each other.

19. The gated camera apparatus (3) according to claim 17, wherein the first illumination device (5.1) and the second illumination device (5.2) are disposed vertically offset from each other.
